(19) United States
(12) Patent Application Publication
(10) Pub. No.: US 2013/0189524 A1
(43) Pub. Date: Jul. 25, 2013

(54) VISCOUS FUGITIVE POLYMER-BASED CARBON NANOTUBE COATINGS

(71) Applicant: Brewer Science Inc., Rolla, MO (US)

(72) Inventors: Molly Hladik, Nixa, MO (US); Michael Stroder, Springfield, MO (US)

(73) Assignee: BREWER SCIENCE INC., Rolla, MO (US)

(21) Appl. No.: 13/747,011

(22) Filed: Jan. 22, 2013

Related U.S. Application Data
(60) Provisional application No. 61/588,244, filed on Jan. 19, 2012.

(51) Int. Cl. C09D 1/00

(52) U.S. Cl. CPC C09D 1/00
USPC 428/412; 252/182.12; 423/445 B; 427/282; 427/372.2; 428/426; 428/446; 428/457; 428/537.5; 428/688; 428/689; 428/698; 428/702; 524/612; 585/422

(57) ABSTRACT

Novel compositions comprising polymer solutions at various viscosities are provided. The polymer solutions are preferably fugitive, so as to avoid interfering with the properties of the nanomaterials after post-processing of the CNT-containing formulations. Additives, including acid generators, are added to the polymer solutions in order to allow the polymer carrier solutions to be degraded or decomposed at temperatures low enough to allow processing of commonly-used polymer film substrates. The invention further allows the carbon nanotube solutions to be screen printed or printed via inkjet.

### RELATED APPLICATIONS

The present application claims the priority benefit of U.S. Provisional Patent Application Ser. No. 61/588,244, filed Jan. 19, 2012, entitled VISCOUS FUGITIVE POLYMER-BASED CARBON NANOTUBE COATINGS, incorporated by reference in its entirety herein.

### FEDERALLY SPONSORED RESEARCH OR DEVELOPMENT

This invention was made with government support under contract number 70NANB10H001 awarded by the National Institute of Standards and Technology—Technology Innovation Program. The United States Government has certain rights in the invention.

### BACKGROUND OF THE INVENTION

1. Field of the Invention

The present invention is concerned with carbon nanotube dispersions including a polymer and an acid generator, as well as methods of forming carbon nanotube films with those dispersions.

2. Description of the Prior Art

Carbon nanotube (CNT) coatings need to be applied in a variety of methods. Many printing techniques require viscous coatings, which necessitate that the CNTs be dispersed into some sort of medium. For example, screen printing requires a very high viscosity that is not easily achieved with the typical methods of dispersing CNTs. Once the CNT coating has been printed, the medium carrying the CNTs has to be removable so that the unique optical and electronic properties of the CNTs are not diminished.

Formulations have been created using a low viscosity surfactant dispersion to apply the CNTs (via spray or rod drawdowns) to get the final desired properties. This method, however, requires a post-application step of washing the film to remove the surfactant so that the CNT properties are not diminished.

Another process involves dispersing the CNTs in a low viscosity medium (acid or amine solvents). Once the CNTs are sufficiently dispersed, CO₂ is bubbled through the sample to create an acid-amine adduct using the hydrogen bonding properties. This process allows the dispersing media to become viscous until heated, and then when heated, the solvents volatilize rapidly, leaving only the CNTs behind. However, this method does not generate long-term stability. The acid-amine adduct made by the CO₂ will degrade at room temperature, causing the viscosity to decrease with time. The adduct can be reformed by bubbling CO₂ back through the sample, but this property causes the necessity for onsite manufacturing, and the product needs to be used immediately after manufacture.

For transparent conductive applications, it is especially important that the polymers either are transparent, or are able to be removed completely. Otherwise, residues may interfere with the transparency of the conductive traces.

### SUMMARY OF INVENTION

The present invention provides a dispersion comprising a polymer, an acid generator, and a plurality of carbon nanotubes.

The present invention also provides a method of forming a carbon nanotube film, where the method comprises providing a dispersion comprising a polymer, an acid generator, and a plurality of carbon nanotubes, and forming a film from said dispersion.

Finally, in another embodiment, the invention is directed towards an article comprising a substrate having a surface. There is a wet (i.e., flowable) layer adjacent the substrate surface, with the layer being formed from a dispersion comprising a polymer, an acid generator, and a plurality of carbon nanotubes.

### BRIEF DESCRIPTION OF THE DRAWINGS

FIG. 1 is a graph showing the weight loss of SSA in PolyTHF as determined in Example 1;

FIG. 2 is a graph of the weight loss of SSA and TAG 2678 in PolyTHF as shown in Example 2; and

FIG. 3 is a graph depicting the weight loss of polypropylene carbonate with various TAGs as described in Example 3.

### DETAILED DESCRIPTION OF THE PREFERRED EMBODIMENTS

The present invention is concerned with methods of forming CNT films that are highly conductive and transparent. This invention is accomplished by providing a composition that is a dispersion of CNTs, a polymer, and an acid generator. More specifically, this invention allows the dispersion of CNTs in a viscous, organic polymer that can be applied via methods such as screen printing. The polymer becomes fugitive at a low temperature in the post-processing of the applied film. The carrier polymer has its decomposition temperature lowered by the addition of an acid generator so that it can be decomposed at sufficiently low temperatures to allow processing of delicate substrates, such as polymer films.

### CNTs

Suitable CNTs for use in the present inventive method include any raw single-walled, double-walled, or multi-walled CNTs (SWCNTs, DWCNTs, and MWCNTs, respectively). Preferably, the CNTs are pristine, that is, CNTs having little or no sidewall defects, existing functionalization, or doping. Exemplary types of CNTs for this process include, but are not limited to, P2 and P3 CNTs from Carbon Solutions, SWCNTs from nano-c, P927 SWCNT and DWCNT from Thomas Swan, CG 200 and SG 76 SWCNTs from SWeNT, Thin Wall DWCNTs from Cheap Tubes, XBC3350 CNTs from CCNI, and HiPco™ CNTs from NanoIntegris.

In addition to raw or pristine CNT's, functionalized CNTs can also be utilized. Examples of suitable functionalities include aromatic moieties, with preferred aromatic moieties being those selected from the group consisting of naphthalene, anthracene, phenanthracene, pyrene, tetracene, tetraphene, chrysene, triphenylene, pentacene, pentaphene, perylene, benzo[a]pyrene, coronene, antanthrene, corannulene, ovalene, graphene, fullerene, cycloparaphenylene, polyparaphenylene, cyclophene, and compounds containing moieties of the foregoing. Further discussion of this type of functionalization can be found in U.S. patent application Ser. No. 13/082,426, incorporated by reference herein.

The CNTs can be any length, but ideally they will have a nominal individual tube length of from about 200 nm to about 3 mm, more preferably from about 500 nm to about 1 mm, and even more preferably from about 1 μm to about 500 μm. Although there will be some “outliers,” preferably, at least about 75%, and more preferably at least about 95% of the tubes will fall within these ranges.

It is typically desirable to add the highest concentration of CNTs possible to the dispersion, in order to increase the required conductive properties. The dispersion preferably comprises from about 0.01% to about 50% by weight CNTs, more preferably from about 0.05% to about 2% by weight CNTs, and even more preferably from about 0.1% to about 1% by weight CNTs, based upon the total weight of the dispersion taken as 100% by weight.

### Polymers

Preferred polymers for use in the inventive dispersions are those that exhibit the desired fugitive properties. Although these properties can be fine-tuned for the particular application, there are ranges of properties that are typically desirable to achieve. For example, the polymer utilized in the present invention should have a degradation temperature of at least about 80° C., preferably from about 60° C. to about 200° C., more preferably from about 70° C. to about 150° C., and even more preferably from about 80° C. to about 120° C.

Various molecular weights could be utilized for the polymers, however, lower molecular weights are typically better for fugitive properties. While the onset temperature for the degradation or decomposition of higher and lower molecular weight polymers is generally the same, the time that it takes for a higher molecular weight polymer to degrade completely is typically much longer than that of its lower molecular weight counterpart. However, lower molecular weights may negatively affect the dispersion process. Combinations of different molecular weights will also work well together, depending on the particular polymer used and the properties needed for the dispersion process. In light of the foregoing considerations, typical weight average molecular weights of the polymers used in the present invention are from about 25,000 Daltons to about 275,000 Daltons, preferably from about 50,000 Daltons to about 250,000 Daltons, and more preferably from about 50,000 Daltons to about 100,000 Daltons. In some embodiments, typical number average molecular weights are from about 100 to about 700, and more preferably from about 250 to about 400.

A number of polymers would be suitable for use in the present inventive dispersions. The most preferred polymers are those that are polymerized via ring-opening polymerization. Such polymers include those formed from monomers comprising ringed moieties having nitrogen (e.g., imides, amines, amides) and/or oxygen (e.g., ethers, carbonates) atoms as part of the ring. Preferred polymers include those that are polymerized from one or more of the following monomers, either alone or as part of a co- or terpolymer:

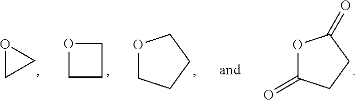

Some specific polymers that can be included in the inventive dispersion include those selected from the group consisting of polyethylene carbonate, polypropylene carbonate, polyethylene glycol, polypropylene glycol, and polytetrahydrofuran (available as Terathane® from Invista and PolyTHF® from BASF).

The polymer (or combination of polymers, in embodiments where more than one polymer is utilized) is typically present in the formulation at a level of from about 5% to about 95% by weight, preferably from about 5% to about 50% by weight, and even more preferably from about 7% to about 25% by weight, based upon the total weight of the dispersion taken as 100% by weight.

### Acid Generators

Although any acid generator (e.g., photoacid generators or “PAGs” as well as thermal acid generators or “TAGs”) could be used to alter the degradation or decomposition temperature of many polymers, TAGs are particularly preferred. Ideally, the acid generator utilized will lower the degradation temperature of the polymer by at least about 50° C., preferably from about 60° C. to about 150° C., and more preferably from about 80° C. to about 100° C.

Suitable TAGs include sulfonic acids (e.g., sulfonic esters, p-toluenesulfonic acid (p-TSA), dinonylnaphthalenesulfonic acid), sulfosalycilic acid (SSA), pyrdine para toluene sulfonate PPTS, alkyl acid phosphate (Nacure 4000 from King Industries), trifilic acids (available as TAG 2678 and TAG 2689 from King Industries), and the like available under the name K-PURE® sold by King Industries.

In some cases, the use of more than one acid generator can have a synergistic effect on the degradation temperature of the polymer. One such combination involves the use of both SSA and TAG 2678 (triflic acid) in Terathane® (a polyether (polyTHF), available from Invista). The combination of TAGs can reduce the onset temperature and increase the rate of degradation more than comparable amounts of either acid generator on its own, or the combination of acid generators with other polymers.

In instances where a PAG is utilized as the acid generator, suitable PAGs include onium salts (e.g., triphenyl sulfonium perfluorosulfonates such as TPS nonaflate, TPS triflate, and substituted forms thereof, such as tris(4-tert-butylphenyl)sulfonium perfluoro-1-butanesulfonate (an alkyl-substituted TPS nonaflate), all available from Sigma-Aldrich); oxime-sulfonates (e.g., those sold under the name CGI® by CIBA); triazines (e.g., TAZ108® available from Midori Kagaku Company); and combinations thereof.

Acid generators may be present in the formulation from about 0.1% to about 50% by weight, preferably from about 5% to about 30% by weight, and more preferably from about 10% to about 15% by weight, based upon the total weight of the dispersion taken as 100% by weight.

### Solvent

In some embodiments, the dispersion consists essentially of, or even consists of, the CNTs, polymer, and acid generator. In other embodiments, additional ingredients can be included. For example, depending on the type of polymer used, the formulations may be solvent-based (e.g., when the polymer is a solid, or when the polymer is a liquid that needs diluting), or they may be solvent-free (e.g., when the polymer is liquid). If a solvent is present, appropriate solvents can include n-methylpyrrolidone (“NMP”), propoxy propanol (“PnP”), butanol, cyclohexanone, and 1,3-propane diol. (In this context, a “solvent” is referring to a conventional solvent, i.e., one that dissolves solids and/or dilutes liquids.) In these embodiments, the solvent is present in the formulation at levels of from about 0.1% to about 95% by weight, preferably from about 10% to about 90% by weight. and more preferably from about 50% to about 80% by weight, based upon the total weight of the dispersion taken as 100% by weight. In solvent-free embodiments, the dispersion comprises less than about 1% by weight solvent, preferably less than about 0.5% by weight solvent, and preferably about 0% by weight solvent.

### Forming and Using the Dispersion

The inventive dispersions are created by simply mixing the above components together. Mechanical dispersion is a preferred method for dispersing the CNTs into the polymer, and 3-roll milling is especially preferred. This allows the CNTs to be debundled to some extent and breaks down any clumps that would affect the deposition method. This results in the CNTs being physically interspersed (and preferably substantially uniformly) among the polymer chains, so that the polymer chains essentially behave as a carrier. Even more preferably, there are no chemical reactions or interactions between the CNTs and the polymer(s).

In use, a layer of the precursor composition is formed on a substrate surface. Suitable substrates include plastics, glass, metals, ceramics, paper, silicon, SiGe, SiO₂, Si₃N₄, SiON, aluminum, tungsten, tungsten silicide, gallium arsenide, germanium, tantalum, tantalum nitride, silicon carbide, sapphire, and gallium nitride, coral, black diamond, phosphorous or boron doped glass, quartz, Ti₃N₄, hafnium, HfO₂, ruthenium, and indium phosphide. Suitable plastics include PET, polyimides, polyester, PEEK, and the like. The layer can be formed by spin-coating, screen-printing, spraying, dipping, inkjet printing, flexo printing, graveure printing, Aerosol Jet® printing, wire rod printing, and slot die printing. In some embodiments, an optional intermediate layer can be present on the substrate surface, in which case the layer of precursor material is applied adjacent the intermediate layer. Exemplary intermediate layers include conductive polymer binders, and adhesion promoters, which help facilitate adhesion of the CNT film to the substrate surface.

Once the material is applied, acid generation is initiated by either light or heat exposure, or both, depending upon the type(s) of acid generator(s) utilized. In instances where a TAG is included, the layer of dispersion is preferably heated to a temperature of from about 100° C. to about 200° C., more preferably from about 125° C. to about 175° C., and even more preferably from about 130° C. to about 150° C. for a time period of from about 30 seconds to about 20 minutes. The acid that is generated from the acid generator attacks and “depolymerizes” the polymer that was included in the dispersion. That is, the acid catalyzes breaking of the bond that was formed among the groups in the polymer, breaking the polymer into smaller constituents. This would typically result in the formation of the same monomers that were used to form the polymer. Heating at the above temperatures and for the above time periods also causes the polymer carrier to be decomposed, leaving the CNTs behind with minimal residue, thus forming the desired CNT film. Thus, the film is preferably essentially free of any polymer or monomer residue, which means that at least about 85% by weight, preferably at least about 90%, and more preferably at least about 99% by weight of the polymer is removed, based upon the initial amount of polymer in the dispersion (before removal) taken as 100% by weight. The same removal percentages would apply to other constituents that were included in the dispersion as well.

In instances where a PAG is utilized, an acid is generated by exposing the dispersion to light having a wavelength of from about 160 nm to about 450 nm for time periods of from about 5 seconds to about 60 seconds (or as high as 20 minutes if heat and light are used). Once the acid is generated, the same mechanism will occur to depolymerize the polymer, followed by heating at the same temperatures and times to remove the residue.

The inventive films will have an average thickness of from about 50 nm to about 150 μm, more preferably from about 100 nm to about 50 μm, and even more preferably from about 100 nm to about 1,000 nm. The average thickness can be determined by taking the average of thickness measurements (e.g., using an ellipsometer) at five different locations of the film. It will be appreciated that multiple films can also be stacked if necessary to achieve the desired thickness. Advantageously, the inventive CNT films having an average thickness of from about 100 nm to about 1,000 nm will have a percent transmittance of at least about 50%, preferably at least about 75%, and even more preferably at least about 85% at wavelengths of from about 160 nm to about 580 nm, more preferably from about 450 nm to about 580 nm, and even more preferably from about 550 nm to about 580 nm. The inventive films will also preferably have a sheet resistance of less than about 5,000 Ω/sq, more preferably less than about 2,000 Ω/sq, and even more preferably less than about 1,000 Ω/sq. Advantageously, not only are the inventive films transparent and conductive, they are also flexible. That is, the inventive films will not crack and/or lose conductivity after being subjected to a mandrel bend test and/or a crease test. In the mandrel bend test, the films are wrapped around a cylindrical mandrel with a tapered diameter to cheek for cracks or failures in the film. The present films can be wrapped around the smallest diameter without cracking or losing conductivity. In the crease test, the films are folded over on each other to form a crease in the film, which is then checked for cracks or failures.

### EXAMPLES

The following examples set forth preferred methods in accordance with the invention. It is to be understood, however, that these examples are provided by way of illustration and nothing therein should be taken as a limitation upon the overall scope of the invention.

### Example 1

### Degradation Testing of PolyTHF and SSA

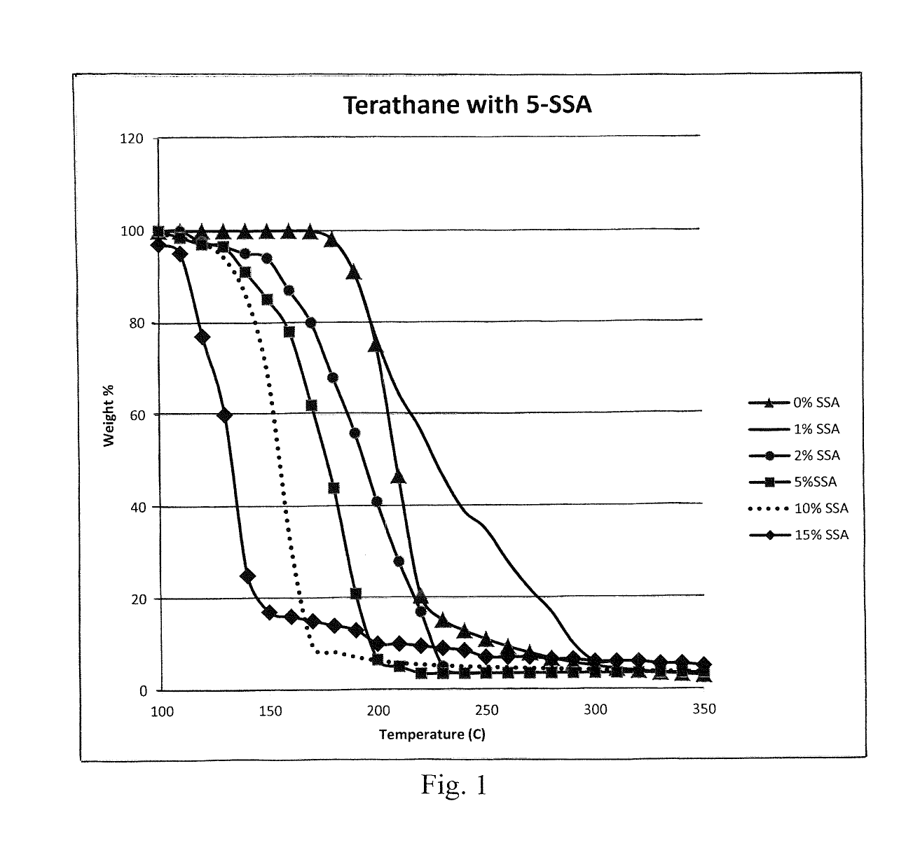

Varying amounts of sulfosalycilic acid (“SSA,” Aldrich, St. Louis, Mo.) were dissolved in polytetrahydrofuran (PolyTHF® 250; Aldrich, St. Louis, Mo.) by stirring or shaking in a vial. These mixtures were tested for weight loss with increasing temperature on a Thermal Analysis TGA by placing a small sample into a ceramic pan on the TGA and ramping the temperature from room temperature to about 600° C. at a rate of 2° C./min. Table 1 shows the composition of the formulations tested. FIG. 1 shows the % weight loss with increasing temperature.

TABLE 1
Formulations of SSA in PolyTHF

| | SSA | PolyTHF |
|---|---|---|
| Formulation | (grams) | (grams) |
| 0% SSA | 0 | 10 |
| 1% SSA | 0.1 | 9.9 |
| 2% SSA | 0.2 | 9.8 |
| 5% SSA | 0.5 | 9.5 |
| 10% SSA | 1.0 | 9.0 |
| 15% SSA | 1.5 | 8.5 |

### Example 2

### Degradation Testing of PolyTHF and SSA with TAG 2678

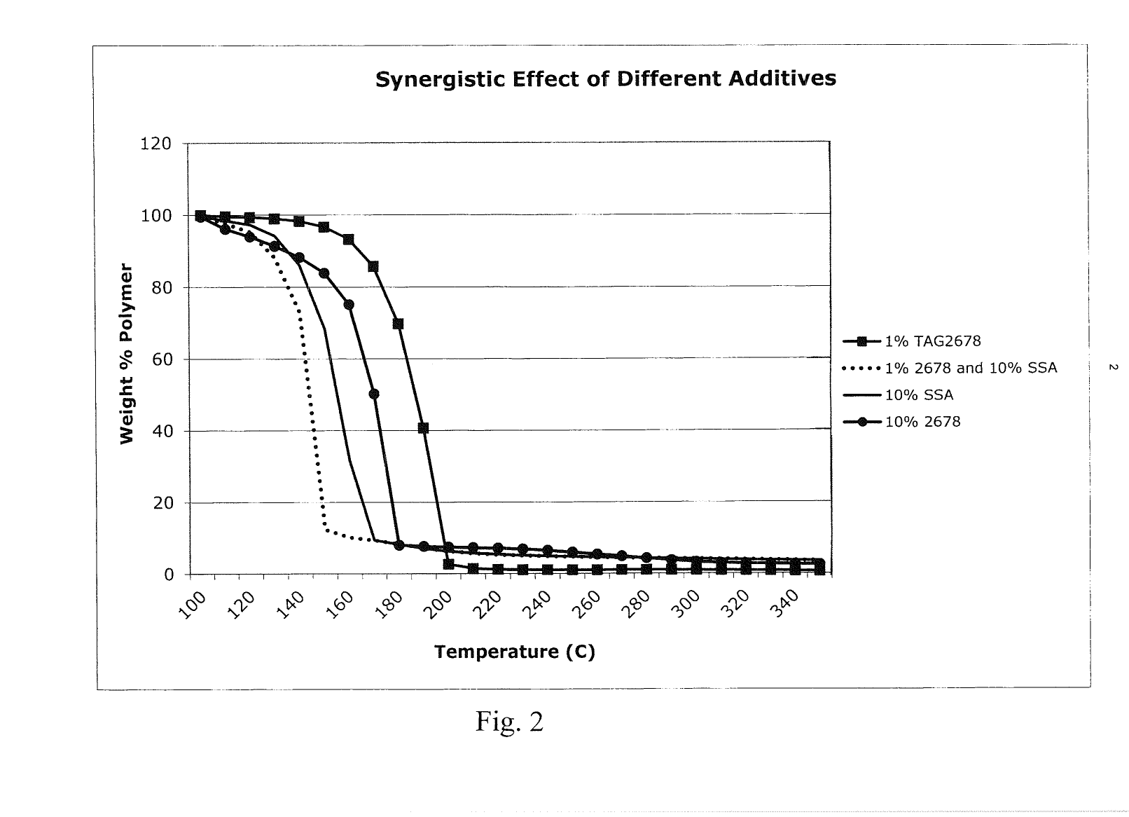

Varying amounts of SSA and TAG 2678 (King Industries, Norwalk, Conn.) were dissolved in polytetrahydrofuran by stirring or shaking in a vial. These mixtures were tested for weight loss with increasing temperature on a Thermal Analysis TGA by placing a small sample into a ceramic pan on the TGA and ramping the temperature from room temperature to about 400° C. at a rate of 2° C./min. Table 2 shows the formulations tested. FIG. 2 shows the % weight loss with increasing temperature.

TABLE 2
Formulations of SSA and TAG 2678 in PolyTHF

| | PolyTHF | SSA | TAG 2678 |
|---|---|---|---|
| Formulation | (grams) | (grams) | (grams) |
| 1% TAG | 9.9 | 0 | 0.1 |
| 1% TAG/10% SSA | 8.9 | 1.0 | 0.1 |
| 10% SSA | 9.0 | 1.0 | 0 |
| 10% TAG | 9.0 | 0 | 1.0 |

### Example 3

### Degradation Testing of Polypropylene Carbonate and TAG 2678 in NMP

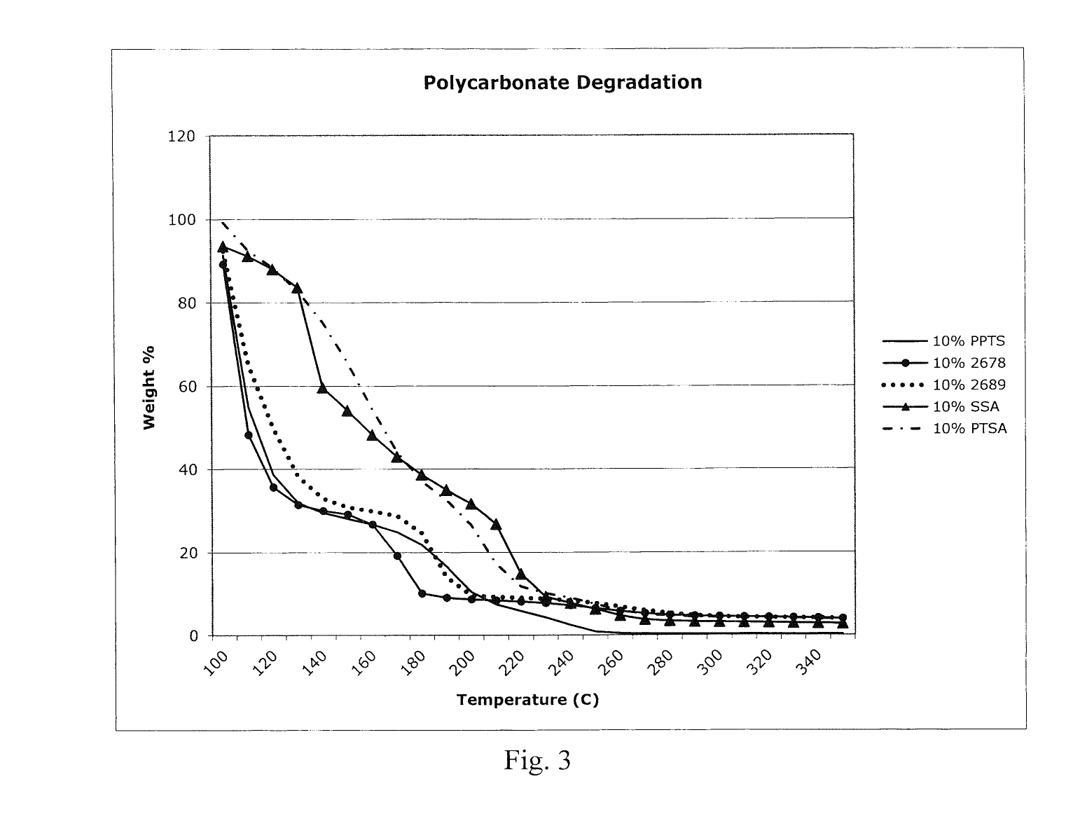

In this procedure, 80 grams of polypropylene carbonate (40%) (Empower Materials, Newcastle, Del.) were dissolved in 120 grams of NMP (Sigma Aldrich, St. Louis, Mo.) by mixing on a stir plate until dissolved. This stock solution was then used to make samples with varying amounts and kinds of TAGs by mixing on a stir plate or sonicating the solutions. These mixtures were tested for weight loss with increasing temperature on a Thermal Analysis TGA by placing a small sample into a ceramic pan on the TGA and ramping the temperature from room temperature to about 400° C. at a rate of 2° C./min. Table 3 shows the composition of the formulations tested. FIG. 3 shows the % weight loss with increasing temperature.

TABLE 3
Formulations of polypropylene carbonate and TAG 2678 in NMP

| | Polypropylene | |
|---|---|---|
| | Carbonate in NMP | TAG |
| Formulation | (grams) | (grams) |
| 10% PPTS | 9.0 | 1.0 |
| (King Industries, Norwalk, CT) | | |
| 10% TAG 2678 | 9.0 | 1.0 |
| (King Industries, Norwalk, CT) | | |
| 10% TAG 2689 | 9.0 | 1.0 |
| (King Industries, Norwalk, CT) | | |
| 10% SSA | 9.0 | 1.0 |
| (Aldrich, St. Louis, MO) | | |
| 10% p-TSA | 9.0 | 1.0 |
| (King Industries, Norwalk, CT) | | |

### Example 4

### Resistance and Transmittance Testing of PolyTHF and SSA with CNTs

In this Example, 100 grams of SSA were dissolved in 900 grams of polytetrahydrofuran by mixing on a stir plate to make a stock solution. Next, 0.3 gram of various kinds of CNTs were added to 99.7 grams of the stock solution by mechanical dispersion using 3 roll milling. Table 4 shows the formulations of each material. This solution was screen printed onto a PET film using a 380 mesh screen on an Atma AT-70TD screen printer and heated in a HIX convection oven at 350° F. at a rate of 4.1 in/min for about 12 minutes. Table 5 shows the resistance measurements and transmittance measurements of two different sheets for each CNT formulation. Resistance was measured using a Miller EFT-5000 4-point probe and transmittance was measured at 550 nm using a UV-Vis spectrometer.

TABLE 4
CNT formulations in PolyTHF with SSA

| | CNTS | SSA in PolyTHF |
|---|---|---|
| Tube Type | (grams) | (grams) |
| P2 | 0.3 | 99.7 |
| (Carbon Solutions, Inc., Riverside, CA) | | |
| Nano-c SWCNT | 0.3 | 99.7 |
| (nano-c, Westwood, MA) | | |
| P927 | 0.3 | 99.7 |
| (Thomas Swan, Durham, UK) | | |
| CG 200 | 0.3 | 99.7 |
| (SWeNT, Norman, OK) | | |
| SG 76 | 0.3 | 99.7 |
| (SWeNT, Norman, OK) | | |
| Thin Wall | 0.3 | 99.7 |
| (Cheap Tubes, Inc., Brattleboro, VT) | | |

TABLE 5
Resistance and transmittance measurements
for CNTS in the PolyTHF with SSA

| Tube Type | Resistance (kΩ/sq) | | | | | % T |
|---|---|---|---|---|---|---|
| P2 | Sheet 1 | 310 | 292 | 255 | 315 | 71 |
| | Sheet 2 | 394 | 315 | 332 | 314 | 71 |
| Nano C | Sheet 1 | 9.89 | 9.66 | 9.35 | 9.81 | 63 |
| | Sheet 2 | 11.95 | 9.61 | 9.65 | 9.65 | 63 |
| P 927 | Sheet 1 | N/R | N/R | N/R | N/R | 71 |
| | Sheet 2 | N/R | N/R | N/R | N/R | 71 |
| CG 200 | Sheet 1 | 71.2 | 56.9 | 51.3 | 46.7 | 67 |
| | Sheet 2 | 44.2 | 46.1 | 36.8 | 38.1 | 67 |
| SG 76 | Sheet 1 | 103.6 | 91.6 | 129.2 | 126.3 | 64 |
| | Sheet 2 | 138.1 | 157.1 | 160.7 | 129.6 | 64 |
| Thin Wall | Sheet 1 | 6.76 | 7.72 | 6.35 | 7.9 | 52 |
| | Sheet 2 | 7.84 | 8.66 | 7.2 | 6.75 | 52 |

### Example 5

### Resistance and Transmittance Testing of PolyTHF and SSA with CNTs with Various Screen Print Mesh Sizes

In this procedure, 100 grams of SSA were dissolved in 900 grams ofpolytetrahydrofuran by mixing on a stir plate to make a stock solution. Various kinds and amounts of CNTs shown in Tables 6 and 7 were added to 99.7 grams of the stock solution by mechanical dispersion using 3-roll milling. This solution was screen printed onto a PET film using a 305 or 390 mesh screen on an Atma AT-70TD screen printer and heated in a HIX convection oven at 350° F. at a rate of 4.1 in/min for about 12 minutes. Each formulation was tested “wet on wet,” where two layers were screen printed without drying in between layers, and compared to “one pass,” which was just one print. Table 6 shows the resistance measurements and transmittance measurements for each CNT formulation with the 305 mesh screen, and Table 7 shows the resistance measurements and transmittance measurements for each CNT formulation with the 390 mesh screen. Resistance was measured using a Miller FPT-5000 4-point probe, and transmittance was measured at 550 nm using a UV-Vis is spectrometer. The 305 mesh screen has a roughly 44-μm size hole in the screen, whereas the 390 mesh screen has a smaller hole size at roughly 37-μm. This allows the smaller mesh (305) to put down more material than the larger mesh screen.

TABLE 6
Resistance and transmittance for
CNTs printed with 305 mesh screen

| | | | Resistance |
|---|---|---|---|
| Tube Type | Print Type | % T | (kΩ/sq) |
| P-3 | wet on wet | 87 | 18100 |
| | 1 pass | 87 | 24400 |
| 0.5% SG-76 | wet on wet | 73 | 2.872 |
| | 1 pass | 73 | 2.984 |
| 1.0% SG-76 | wet on wet | 69 | 1.985 |
| | 1 pass | 70 | 2.268 |

TABLE 7
Resistance and transmittance for
CNTs printed with 390 mesh screen

| | | | Resistance |
|---|---|---|---|
| Tube Type | Print Type | % T | (kΩ/sq) |
| P-3 | wet on wet | 90.5 | 43000 |
| | 1 pass | 91.5 | 50200 |
| 0.5% SG-76 | wet on wet | 79 | 3.942 |
| | 1 pass | 78 | 4.049 |
| 1.0% SG-76 | wet on wet | 73 | 2.434 |
| | 1 pass | 73 | 2.449 |

### Comparative Example 6

### Resistance and Transmittance Testing of Polypropylene Glycol with CNTs with Various Screen Print Mesh Sizes

Various amounts and kinds of CNTs and other additives were added to polypropylene glycol 400 (PPG) (Aldrich, St. Louis, Mo.) using 3-roll milling. Polypropylene glycol was selected as a comparative example because it boils at about 185° C. but has a flash point of 130° C., so it should have shown similar behavior to the inventive compositions. Table 8 shows the formulations of each material. This solution was screen printed onto a PET substrate using a 305 mesh screen or a 390 mesh screen on an Atma AT-70TD screen printer, and heated in a HIX convection oven at 350° F. at a rate of 4.1 in/min for about 12 minutes. Table 9 shows the resistance measurements and transmittance measurements for each CNT formulation with the 305 mesh screen, and Table 10 shows the resistance measurements and transmittance measurements for each CNT formulation with the 390 mesh screen. The layers were tested in four different spots on each printed substrate to test variance across the sheet. Resistance was measured using a Miller FPT-5000 4-point probe, and transmittance was measured at 550 nm using a UV-Vis spectrometer.

TABLE 8
Formulations of various PPG-CNT materials

| | | | | s- | s- | CG | | |
|---|---|---|---|---|---|---|---|---|
| | PPG | SG-76 | TWNT | TWNT | SWNT | 200 | Aquivion | PEDOT |
| | (g) | (g) | (g) | (g)* | (g)** | (g) | (g)*** | (g)**** |
| 1 | 9.95 | 0.05 | | | | | | |
| 2 | 9.95 | | 0.05 | | | | | |
| 3 | 9.90 | | 0.1 | | | | | |
| 4 | 9.90 | | 0.05 | 0.05 | | | | |
| 5 | 9.85 | | 0.05 | 0.1 | | | | |
| 6 | 9.85 | | 0.05 | | 0.1 | | | |
| 7 | 9.95 | | | | | 0.05 | | |
| 8 | 9.90 | | 0.05 | | | | 0.05 | |
| 9 | 9.9375 | | 0.05 | | | | | 0.0125 |

*s-TWNT—short thin-walled nanotubes (Cheaptubes.com)
**s-SWNT—short single-walled nanotubes (Cheaptubes.com)
***Aquivion—ionic conductive polymer (Solvay, Belgium)
****PEDOT—conductive polymer (Sigma Aldrich, St. Louis, MO

TABLE 9
Resistance and transmittance for PPG-CNT formulations
printed with a 305 mesh screen

| | Sheet Resistance (kΩ/sq) | | | | Transmittance | | | |
|---|---|---|---|---|---|---|---|---|
| | a | b | c | d | a | b | c | d |
| 1 | 4157.1 | 2570.2 | 2642.2 | 4048.7 | 90.7 | 90.7 | 90.7 | 90.7 |
| 2 | 52.9 | 44.4 | 60.5 | 52.7 | 83 | 82.6 | 82.8 | 82.8 |
| 3 | 8.8 | 9.4 | 9.7 | 8.8 | 67.6 | 66.9 | 66.6 | 66.2 |
| 4 | 6.2 | 6.5 | 6.6 | 5.8 | 65.2 | 65.2 | 64.6 | 64.6 |
| 5 | 4.6 | 4.8 | 4.6 | 4.7 | 66.9 | 67.7 | 68.3 | 67 |
| 6 | 19.9 | 20.7 | 19.4 | 20.2 | 72.5 | 72.5 | 73 | 72.2 |
| 7 | 25.4 | 42.2 | 25.5 | 55.4 | 92.8 | 94.3 | 93.1 | 93.3 |
| 8 | 47.6 | 64.6 | 66.3 | 64.7 | 78.8 | 80.2 | 80.5 | 80.5 |
| 9 | 24.4 | 21.9 | 26.1 | 24.8 | 79 | 78.3 | 78.8 | 79.5 |

TABLE 10
Resistance and transmittance for PPG-CNT formulations
printed with a 390 mesh screen

| | Sheet Resistance (kΩ/sq) | | | | Transmittance | | | |
|---|---|---|---|---|---|---|---|---|
| | a | b | c | d | a | b | c | d |
| 1 | 1758.5 | 2011.4 | 1787.8 | 1212.5 | 92.2 | 92.1 | 92.4 | 92.2 |
| 2 | 418.1 | 389.4 | 381.1 | 365.3 | 89.3 | 89.3 | 89.7 | 89.5 |
| 3 | 43.2 | 48.3 | 39.3 | 16.6 | 69.2 | 75.7 | 78.3 | 77.8 |
| 4 | 11.5 | 15.2 | 12.6 | 11.5 | 70.4 | 72 | 71.4 | 71.7 |
| 5 | 6.2 | 6.5 | 7.2 | 6.5 | 71.3 | 72.2 | 72 | 71.4 |
| 6 | 84.0 | 93.5 | 102.2 | 115.5 | 81.6 | 81.7 | 81.7 | 80.3 |
| 7 | | | | | | | | |
| 8 | 121.0 | 123.6 | 126.6 | 123.9 | 85.3 | 85.7 | 69.2 | 85.5 |
| 9 | 154.3 | 140.4 | 160.8 | 181.9 | 88.5 | 88 | 88.3 | 88.5 |

### Example 7

### Resistance and Transmittance Testing of PolyTHF and SSA with CNTs with Various Screen Print Mesh Sizes

Various amounts of SSA and TAG 2678 were dissolved in polytetrahydrofuran by mixing on a stir plate. Various amounts and kinds of CNTs and other additives were added to the stock solution using 3-roll milling. Table 11 shows the formulations of each material. This solution was screen printed onto a PET substrate using a 305 mesh screen or a 390 mesh screen on an Atma AT-70TD screen printer, and heated in a MX convection oven at 350° F. at a rate of 4.1 in/min for about 12 minutes. Table 12 shows the resistance measurements and transmittance measurements for each CNT formulation with the 305 mesh screen, and Table 13 shows the resistance measurements and transmittance measurements for each CNT formulation with the 390 mesh screen. The layers were tested in four different spots on each printed substrate to test variance across the sheet. Resistance was measured using a Miller FPT-5000 4-point probe, and transmittance was measured at 550 nm using a UV-Vis spectrometer.

TABLE 11
Formulations of SSA/TAG/PolyTHF/CNT mixtures

| | PolyTHF | SSA | TAG 2678 | SG-76 | P3 |
|---|---|---|---|---|---|
| | (g) | (g) | (g) | (g) | (g) |
| 1 | 9.35 | 0.5 | 0.1 | 0.05 | |
| 2 | 8.8 | 1.0 | | 0.1 | 0.1 |
| 3 | 8.85 | 1.0 | | 0.05 | 0.1 |

TABLE 12
Resistance and transmittance for SSA/PolyTHF/CNT
mixtures printed with 305 mesh screen

| | Sheet Resistance (kΩ/sq) | | | | Transmittance | | | |
|---|---|---|---|---|---|---|---|---|
| | a | b | c | d | a | b | c | d |
| 1 | 9.9 | 9.5 | 9.9 | 9.0 | 80.9 | 80.9 | 80.7 | 80.8 |
| 2 | 4.5 | 4.5 | 5.0 | 4.6 | 68.7 | 67.9 | 69.4 | 68.6 |
| 3 | 5.8 | 5.8 | ??? | 5.8 | 69.2 | 69 | 69.5 | 68.9 |

TABLE 13
Resistance and transmittance for SSA/PolyTHF/CNT
mixtures printed with 390 mesh screen

| | Sheet Resistance (kΩ/sq | | | | Transmittance | | | |
|---|---|---|---|---|---|---|---|---|
| | a | b | c | d | a | b | c | d |
| 1 | 9.3 | 9.8 | 9.9 | 8.5 | 82.3 | 81.7 | 82.1 | 82.1 |
| 2 | 4.3 | 3.9 | 4.6 | 4.6 | 73.9 | 73.4 | 73.4 | 73.1 |
| 3 | 11.0 | 10.4 | 11.0 | 9.9 | 77.1 | 77.1 | 77.3 | 77.1 |

### Example 8

### Resistance Testing of a High-Solvent PolyTHF and SSA Formulation

In this procedure, 1 gram of SSA, 2 grams of polytetrahydrofuran, 0.1 gram of TAG 2678, and 0.1625 gram CG 300× (SWeNT, Norman, Okla.) were dissolved in 21.74 grams of propyleneglycol n-propyl ether (Sigma Aldrich, St. Louis, Mo.) by stirring or shaking in a vial. This mixture was screen printed onto a Kapton® film using a 60 mesh screen. Table 14 shows the sheet resistance of the printed film compared to a comparable solvent-less formulation (Formulation 7-3 from Example 7).

TABLE 14
Resistance for SSA/PolyTHF/CNT mixtures
printed with 60 mesh screen

| | Sheet Resistance (Ω/sq) |
|---|---|
| 1 | 18 |
| 2 | 900 |

We claim:

1. A dispersion comprising a polymer, an acid generator, and a plurality of carbon nanotubes.

2. The dispersion of claim 1, wherein the carbon nanotube concentration in the dispersion is from about 0.1% to about 50% by weight, based upon the total weight of the dispersion taken as 100% by weight.

3. The dispersion of claim 1, wherein the dispersion can be formed into a film having a sheet resistance of less than about 5,000 Ω/sq.

4. The dispersion of claim 1, wherein said polymer comprises a plurality of polymer chains, and said carbon nanotubes are physically interspersed among said polymer chains.

5. The dispersion of claim 4, wherein there are no chemical reactions between said polymer chains and said carbon nanotubes.

6. The dispersion of claim 1, wherein said polymer is selected from the group consisting of polyethylene carbonate, polypropylene carbonate, polyethylene glycol, polypropylene glycol, and polytetrahydrofuran.

7. The dispersion of claim 1, wherein said polymer is formed from monomers having a formula selected from the group consisting of

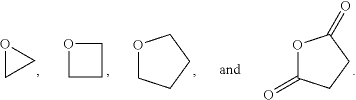

8. The dispersion of claim 1, wherein said polymer is present at levels of from about 5% to about 95% by weight, based upon the total weight of the dispersion taken as 100% by weight.

9. The dispersion of claim 1, wherein said acid generator is selected from the group consisting of thermal acid generators and photoacid generators.

10. The dispersion of claim 1, wherein said CNTs are selected from the group consisting of
(a) raw CNTs;
(b) pristine CNTs;
(c) functionalized CNTs; and
(d) mixtures of (a)-(b).

11. The dispersion of claim 10, wherein said functionalized CNTs are functionalized with an aromatic moiety.

12. The dispersion of claim 11, wherein said aromatic moiety is selected from the group consisting of naphthalene, anthracene, phenanthracene, pyrene, tetracene, tetraphene, chrysene, triphenylene, pentacene, pentaphene, perylene, benzo[a]pyrene, coronene, antanthrene, corannulene, ovalene, graphene, fullerene, cycloparaphenylenc, polyparaphenylene, cyclophene, and compounds containing moieties of the foregoing.

13. A method of forming a carbon nanotube film, said method comprising:
providing a dispersion comprising a polymer, an acid generator, and a plurality of carbon nanotubes; and
forming a film from said dispersion.

14. The method of claim 13, wherein said film is flexible.

15. The method of claim 13, wherein said film has a sheet resistance of less than about 5,000 Ω/sq.

16. The method of claim 13, wherein said film at an average thickness of from about 100 nm to about 1,000 nm, has a % transmittance of at least about 50%, at wavelengths ranging from about 160 nm to about 450 nm.

17. The method of claim 13, wherein said plurality of carbon nanotubes have a nominal tube length of from about 200 nm to about 3 mm.

18. The method of claim 13, wherein the carbon nanotube concentration in the dispersion is from about 0.1% to about 50% by weight, based upon the total weight of the dispersion taken as 100% by weight.

19. The method of claim 13, wherein the dispersion can be formed into a film having a sheet resistance of less than about 5,000 Ω/sq.

20. The method of claim 13, wherein said polymer comprises a plurality of polymer chains, and said carbon nanotubes are physically interspersed among said polymer chains.

21. The method of claim 20, wherein there are no chemical reactions between said polymer chains and said carbon nanotubes.

22. The method of claim 13, wherein said polymer is selected from the group consisting of polyethylene carbonate, polypropylene carbonate, polyethylene glycol, polypropylene glycol, and polytetrahydrofuran.

23. The method of claim 13, wherein said polymer is formed from monomers having a formula selected from the group consisting of

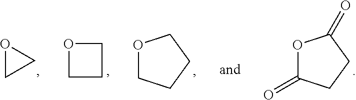

24. The method of claim 13, wherein said acid generator is selected from the group consisting of thermal acid generators and photoacid generators.

25. The method of claim 13, wherein said forming comprises screen-printing said composition onto said substrate surface.

26. The method of claim 13, wherein said forming comprises causing said acid generator to generate an acid.

27. The method of claim 26, wherein said acid breaks said polymer into smaller constituents.

28. The method of claim 27, wherein said forming further comprises heating said smaller constituents to a temperature sufficiently high to cause said constituents to evaporate.

29. The method of claim 28, wherein said temperature is from about 100° C. to about 200° C.

30. The method of claim 28, wherein said film is essentially free of said polymer and constituents after said heating.

31. The method of claim 13, wherein said film has an average thickness of from about 50 nm to about 150 μm.

32. The method of claim 13, wherein said substrate is selected from the group consisting of plastics, glass, metals, ceramics, paper, silicon, SiGe, SiO₂, Si₃N₄, SiON, aluminum, tungsten, tungsten silicide, gallium arsenide, germanium, tantalum, tantalum nitride, silicon carbide, sapphire, and gallium nitride, coral, black diamond, phosphorous or boron doped glass, quartz, Ti₃N₄, hafnium, HfO₂, ruthenium, and indium phosphide.

33. The method of claim 13, wherein said CNTs are selected from the group consisting of:
(a) raw CNTs;
(b) pristine CNTs;
(c) functionalized CNTs; and
(d) mixtures of (a)-(b).

34. The method of claim 33, wherein said functionalized CNTs are functionalized with an aromatic moiety.

35. The method of claim 34, wherein said aromatic moiety is selected from the group consisting of naphthalene, anthracene, phenanthracene, pyrene, tetracene, tetraphene, chrysene, triphenylene, pentacene, pentaphene, perylene, benzo[a]pyrene, coronene, antanthrene, corannulene, ovalene, graphene, fullerene, cycloparaphenylene, polyparaphenylene, cyclophene, and compounds containing moieties of the foregoing.

36. An article comprising:
a substrate having a surface; and
a wet layer adjacent said substrate surface, said layer being formed from a dispersion comprising a polymer, an acid generator, and a plurality of carbon nanotubes.

37. The article of claim 36, wherein the carbon nanotube concentration in the dispersion is from about 0.1% to about 50% by weight, based upon the total weight of the dispersion taken as 100% by weight.

38. The article of claim 36, wherein the dispersion can be formed into a dried film having a sheet resistance of less than about 5,000 Ω/sq.

39. The article of claim 36, wherein said polymer comprises a plurality of polymer chains, and said carbon nanotubes are physically interspersed among said polymer chains.

40. The article of claim 39, wherein there are no chemical reactions between said polymer chains and said carbon nanotubes.

41. The article of claim 36, wherein said polymer is selected from the group consisting of polyethylene carbonate, polypropylene carbonate, polyethylene glycol, polypropylene glycol, and polytetrahydrofuran.

42. The article of claim 36, wherein said polymer is formed from monomers having a formula selected from the group consisting of

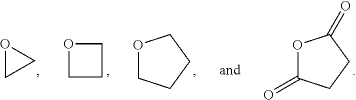

43. The article of claim 36, wherein said acid generator is selected from the group consisting of thermal acid generators and photoacid generators.

44. The article of claim 36, wherein said substrate is selected from the group consisting of plastics, glass, metals, ceramics, paper, silicon, SiGe, SiO₂, Si₃N₄, SiON, aluminum, tungsten, tungsten silicide, gallium arsenide, germanium, tantalum, tantalum nitride, silicon carbide, sapphire, and gallium nitride, coral, black diamond, phosphorous or boron doped glass, quartz, Ti₃N₄, hafnium, HfO₂, ruthenium, and indium phosphide.

45. The article of claim 36, wherein said CNTs are selected from the group consisting of:
(a) raw CNTs;
(b) pristine CNTs;
(c) functionalized CNTs; and
(d) mixtures of (a)-(b).

46. The article of claim 45, wherein said functionalized CNTs arc functionalized with an aromatic moiety.

47. The article of claim 46, wherein said aromatic moiety is selected from the group consisting of naphthalene, anthracene, phenanthracene, pyrene, tetracene, tetraphene, chrysenc, triphenylene, pentacene, pentaphene, perylene, benzo[a]pyrene, coronene, antanthrene, corannuiene, ovalene, graphene, fuilerene, cycioparaphenylene, polyparaphenylene, cyclophene, and compounds containing moieties of the foregoing.
